(19) United States
(12) Patent Application Publication
(10) Pub. No.: US 2017/0139485 A1
(43) Pub. Date: May 18, 2017

(54) MOBILE COMMUNICATION DEVICE, MOBILE COMMUNICATION SYSTEM, AND METHOD PERFORMED THEREBY

(71) Applicant: ASCOM SWEDEN AB, Goteborg (SE)

(72) Inventors: Linnea Fogelmark, Goteborg (SE); Martin Huss, Molndal (SE)

(21) Appl. No.: 15/359,631

(22) Filed: Nov. 23, 2016

Related U.S. Application Data
(63) Continuation of application No. PCT/SE2015/050535, filed on May 12, 2015.

(30) Foreign Application Priority Data
May 23, 2014 (SE) 1450620-8

(51) Int. Cl. G06F 3/01; G06F 3/0346; G06F 1/16; H04W 4/02; H04M 1/725

(52) U.S. Cl. CPC G06F 3/017; H04W 4/023; H04M 1/7258; G06F 1/1647; G06F 3/0346; G06F 1/1694; H04B 2001/3855

(57) ABSTRACT

A mobile communication device, method, and system comprising a first and second display adapted to present information to a user. The first display is arranged on a front side of said mobile communication device and said second display is arranged, substantially perpendicular to said front side, on a top side of said mobile communication device, wherein said mobile communication device further comprises a touch-free interaction arrangement arranged on the top side of said mobile communication device.

### TECHNICAL FIELD

The present invention relates generally to a mobile communication device that allows personnel to receive relevant information and interact with the device without the need of making any physical manipulation.

### BACKGROUND ART

In clinical environments, such as hospitals and treatment centers, communication amongst personnel in different work functions is important and in many cases a lifesaving function that coordinates resources depending on patient needs. Doctors, nurses, and other personnel at such facilities often communicate through mobile devices such as pagers or personal digital assistants (PDAs) that handle alarms, task assignments, messages, alerts, and voice calls.

In prior art mobile devices for clinical environments are different sorts of pagers that provide information to users by receiving and presenting information. Some pagers comprise more advanced features allowing the user to respond to the information provided, for example by pressing at least one button on the pager. Hospitals and other clinical environments require rigorous hygiene procedures in order to minimize contagion and hand disinfection generally applies. This introduces a problem in relation to the mobile communication devices and the usage thereof. In prior art it is known that handheld devices, such as mobile communication devices, attracts bacteria and dirt especially to the surfaces, buttons, and controls that the user operates the device with. Furthermore, the device itself, even in the best case scenario, is riddled with contaminants that will adhere to the healthcare professional's hands upon contact. This characteristic poses the problem to operate mobile communication devices while working in clean environments or while treating patients without transforming such devices in points of contagion.

In addition to those difficulties it is important that such devices can be carried by the user the entire day in situations where the device will be exposed to both dirt and bacteria, as well as in situations where the user's hands are disinfected or in those in which they are not. Keeping the device clean enough is thereby not a realistic option although such solutions previously has been close at hand to the person skilled in the art.

Furthermore, many heath care professionals work in environments where it is preferred to avoid having mobile devices exposed or mounted in such a way that it will impede the user from providing a service to her or his patient. A preferred solution is to adapt the mobile communication device to be concealed in for example a pocket which in turn might be contaminated by the mechanism described before.

The aforementioned difficulties provide a problem that has not yet been formulated in prior art; hence it would be beneficial to provide a device which will provide healthcare professionals a way to interact with the device without risking having their hands contaminated with bacteria or any other. Such a solution needs to address both monitoring and controlling the mobile communication device without any physical contact that might jeopardize the disinfection of the user's hands. Furthermore, the controls need to be user friendly and failsafe in order to avoid any misuse. Additionally, it would be beneficial if such a device can be carried in a similar way that normal mobile communication devices of the prior art, for example a pager, are carried today.

### SUMMARY OF INVENTION

An object of the present invention is to provide a mobile communication device that can be operated by a user without any form of physical interaction.

The person skilled in the art understands that the invention may be utilized in other fields than clinical environments without modification. For example, situations wherein it would be beneficial for a user not to touch the mobile communication device. This could for example be situations where the user has dirty hands such as during construction or mechanical work.

In order to reach a solution for this problem, numerous different systems have to be adopted to create a device comprising means for both interaction and digital information presentation while being arranged in a way that the user can use the device without actually touching it. Furthermore, since the device needs to be carried by the user, preferably at least for one working day at a time, the mobile communication device also needs to be designed in a way that it can be carried with ease.

For the purpose of solving this problem it is further acknowledged that such devices preferably may be worn in for example a breast pocket or attached to a belt. The skilled person although understands that the mobile communication device can be carried in any suitable way that fulfill the requirements for the application area.

These objects are achieved by the mobile communication device, a mobile communication system, and a method as set forth in the appended claims.

Thus, the invention relates to a mobile communication device comprising a first and second displays adapted to present information to a user. The first display is arranged on a front side of said mobile communication device and said second display is arranged, substantially perpendicular to said front side, on a top side of said mobile communication device, wherein said mobile communication device further comprises a touch-free interaction arrangement arranged on the top side of said mobile communication device.

The mobile communication device traditionally is a pager or PDA but it is understood that the mobile communication device can be any form of suitable mobile communication device. The first and second displays are digital displays adapted to dynamically show different graphical information consisting of at least one presentation out of a character, number, or symbol. Examples of such displays are LED-displays, LCD-displays, or any other form of display technology.

The arrangement of the first and second display allows for different usages, for example, the first display is arranged on the front side of the mobile communication device and is in one embodiment adapted to be used during normal operation where the user holds the mobile communication device preferably in his or her hands. The second display is arranged substantially perpendicular to the first display on a top side of the mobile communication device. This means that the information presented on the second display can be viewed from above when the device is correctly placed in the pocket. I.e. when the mobile communication device is tucked in to a pocket, the second display can still be viewed either through the opening in the pocket or if the mobile communication device is extending out through the opening of the pocket.

The person skilled in the art understands that the touch-free interaction arrangement can be any form of arrangement for touch-free interaction that for example identifies a gesture performed by the user. Such an arrangement could in one embodiment for example be an IR-sensor, but in another embodiment be an ultrasound sensor, accelerometer, light sensor, proximity sensor, or any other form of suitable sensor.

According to one embodiment, the touch-free interaction arrangement is not referred to as any form of voice command or command spoken to the mobile communication device.

In one embodiment of the mobile communication device, the touch-free interaction arrangement comprises a movement sensor, preferably an accelerometer, a gyro, or a level.

In one embodiment of the mobile communication device said touch-free interaction arrangement solely can be used when said second display is in an active mode.

In one preferred embodiment of the invention the touch-free interaction arrangement is only active when the second display is in an active mode, i.e. when the second display is presenting some form of information. This means that the touch-free interaction arrangement in such an embodiment would not perform any action based on input received when the second display is inactive.

However, in one embodiment of the invention an exception to the inactive function exists wherein an unlock gesture can be used to activate either the touch-free interaction arrangement or both the touch-free interaction arrangement and the second display.

The person skilled in the art further understands that the touch-free interaction arrangement in preferred embodiment could be inactive when the first display is in an active mode.

In one embodiment of the mobile communication device the touch-free interaction arrangement is adapted to receive user input and determine differences between gestures performed in the close vicinity of said touch-free interaction arrangement.

For the purposes of reference, gestures refers to manual gestures which need to be performed by the user in vicinity of the mobile device and the touch-free interaction arrangement is adapted to detect differences between disparate gestures.

In one embodiment of the mobile communication device said mobile communication device is further arranged to communicate with a mobile communication arrangement comprising an information priority system.

In order to provide information to the right individual an information priority system might be arranged in a mobile communication arrangement that is adapted to create a priority list of which users to send the information to depending on the characteristics of the alarm, message, information, task assignment, alert, or call. The mobile communication arrangement can be any form of mobile communication network comprising of multiple mobile communication devices. Furthermore, the mobile communication arrangement might comprise main units, base stations, servers, or any other form of communication units. The communication between mobile communication devices, and/or any other device within the mobile communication arrangement can be performed through for example GSM, 3G, LTE, voice over Wifi, Bluetooth, WiFi, ZigBee, or any other form of wireless communication protocol or wireless communication technology.

In one preferred embodiment the mobile communication device further comprises means for securing said mobile communication device, preferably in a breast pocket of a user.

Especially in clinical environments it is common to wear mobile communication devices in the breast pocket, and as part of the invention and the utilization of the invention it is important to be able to secure the mobile communication device in a way that it can viewed with ease. The means for securing the mobile communication device can be any form of means such as a high friction layer, preferably arranged on the back of said mobile communication device, or any other form of means for securing the device.

In one embodiment of the mobile communication device said means for securing said mobile communication device is a clip adapted to secure said mobile communication device to enable a clear view of said second display for the user.

The clip is arranged in a way that it allows the user to view the second display at any time. The clip can be any form of clip adapted to secure the mobile communication device. The clip can in one embodiment be a spring loaded clip that can be operated by the user. In another embodiment it might be a plastic clip utilizing the flexibility in the material of the clip. The design of the clip is conventional in the art and it is understood that any form of clip could be introduced by the person skilled in the art within the scope of the invention.

In one embodiment of the mobile communication device said mobile communication device further comprises means to enable determination of the location of said mobile communication device.

The means to enable determination of the location of the mobile communication device can be any form of means adapted to enable determination of the location including but not limited to GPS, GLONASS, WiFi triangulation, or any other form of indoor or outdoor localization system. This means that the means for enable determination of the mobile communication system might be located either in the mobile communication device, such as the case when using for example GPS, or anywhere else in the mobile communication arrangement. For example, in one embodiment of the invention the means for localization of the mobile communication device can be adapted to use any method known to the person skilled in the art to determine the position.

In one embodiment the means for determination of the location of a mobile communication device are part of the information priority system enabling information to be provided to for example the closest person fulfilling some specific requirements.

In one embodiment the mobile communication device comprises a single button located under said first display, a proximity sensor arranged above said display, and volume buttons on one of the sides of said mobile communication device, wherein the touch-free interaction arrangement and the second display are arranged under a collective housing on said top surface.

According to one aspect of the invention a system comprises a mobile communication device, wherein said system comprises a host with an information priority system adapted to communicate with at least one mobile communication device.

In one embodiment a system comprises a host that contains the information priority system; the host can be any form of server, main unit, or other device that may serve as a host in a mobile communication system.

In one embodiment the system comprising the information priority system prioritize information sent to a mobile communication device based on at least one parameter chosen from, user qualifications, user position, user work load, and if the user is on duty or not.

The information priority system decides which user to first send the information to. For example, the information might be an alarm and the closest person fulfills the requirements to respond to the alarm. The information priority system then sends the information to that user. In another case the person closest to the location where assistance is required dose not fulfill the requirements and the information is sent to another user that meets the criteria. It is understood that the information priority system might be either of a true and false type or with number priorities for each category, alternatively any combination thereof. For example, each user might be ranked on a scale from 1 to n, wherein n is any real number, depending on the number of meters from the location, 1 to n depending on their experience level etc. Then the information priority system can decide which user to notify. However, it is further understood that if for example an alarm is not considered critical a user with less experience might be notified even though a more experienced user is close by, or vice versa.

According to yet another aspect a mobile communication device comprises a first and second display adapted to present information to a user. The first display is arranged on a front side of said mobile communication device and said second display is arranged, substantially perpendicular to said front side, on a top side of said mobile communication device. The mobile communication device further comprises a touch-free interaction arrangement arranged on the top side of said mobile communication device for enabling touch-free interaction, comprising the steps:
receiving a message to said mobile communication device,
presenting said message on the second display so that a user can interpret the information without touching or moving said mobile communication device,
enabling said touch-free interaction arrangement,
receiving input from a user through said touch-free interaction arrangement, and
generating an output based on said input.

The mobile communication device is preferably placed by the user in a way that the second display can be viewed at all time. For example, in one embodiment the mobile communication device is preferably arranged within the breast pocket of the user. This allows the user to look down at the second display without moving the mobile communication device at all. In so doing, it is possible to receive information without touching anything. I.e. when a message, or any other form of information, is received to the mobile communication device the information is presented on the second display. The user can interpret the information from looking down on the second display without actually touching anything related to the mobile communication device. When the information is received the user has the possibility to interact with the mobile communication device through the touch-free interaction arrangement. This can be conducted for example through gestures, by covering a sensor, or by provide input to an accelerometer through for example a rapid movement of the body or by hitting the device with the arm. The purpose is to enable interaction without requiring the user to touch the device with his or her hands.

Output generated from the mobile communication device can be any form of output, for example a signal sent to another mobile communication device comprising information such as a confirmation or a forwarding of an assignment or task.

In one embodiment in a mobile communication device the following steps are performed in said mobile communication device:
waiting for incoming digital input in a normal state,
receiving digital input,
upon receipt of said digital input enter a listening state and start listening for user input,
upon receipt of said user input produce an output, and
returning to said normal state.

Different states refer to different modes in a mobile communication device, preferably established by software code.

In another embodiment of a mobile communication device said user input are gestures performed in the close vicinity of said touch-free interaction arrangement.

According to another aspect a computer program comprising computer readable code means causes the mobile communication device to perform the following steps when run in a mobile communication device:
waiting for incoming digital input in a normal state,
receiving digital input,
upon receipt of said digital input enter a listening state and start listening for user input,
upon receipt of said user input produce an output, and
returning to said normal state.

In one embodiment the mobile communication device comprises a memory, a processor, and a communication arrangement, such as a GSM, 3G, LTE, or WiFi chip.

In another embodiment said user input are gestures performed in the close vicinity of said touch-free interaction arrangement.

Gestures can be any form of gestures, for example movement of a hand above the device, covering a sensor, or by another means interaction with a mobile communication device without physically touching it.

In one embodiment of the invention the mobile communication arrangement is a peer-to-peer system which further comprises a message priority arrangement arranged in said mobile communication device. In such a peer-to-peer system no backend solution is required, instead the mobile communication devices are adapted to communicate between each other through creating a network of devices working as a crowd performing determinations of for example which user that shall be notified.

### BRIEF DESCRIPTION OF DRAWINGS

The invention is now described, by way of example, with reference to the accompanying drawings, in which:

FIG. 1 illustrates an isometric view of one embodiment of a mobile communication device comprising a first and second display and at least one touch-free interaction arrangement.

FIG. 2 illustrates one embodiment of the mobile communication device placed in an operational state in a pocket or case of a user.

FIG. 3 illustrates a back view of the mobile communication device and some proposed touch-free interaction gestures.

FIG. 4 illustrate another isometric view of one embodiment of a mobile communication device further comprising a clip adapted to secure the mobile communication device to for example a pocket.

FIG. 5 illustrates an isometric view of another embodiment of the mobile communication device without the clip.

FIG. 6 illustrates a front view of the mobile communication device.

FIG. 7 illustrates a top view of the mobile communication device.

FIG. 8 illustrates a schematic view of one embodiment of the touch-free interaction of the invention in a first mobile communication device.

FIG. 9 illustrates a schematic view of another embodiment of the touch-free interaction of the invention in a first and second mobile communication device.

FIG. 10 illustrates a schematic view of another embodiment of the touch-free interaction of the invention in a first and second mobile communication device and a host.

FIG. 11 illustrates a mobile communication arrangement comprising multiple mobile communication devices.

FIG. 12 illustrates a schematic view of one embodiment of the mobile communication device wherein information is received.

FIG. 13 illustrates a mobile communication device.

### DESCRIPTION OF EMBODIMENTS

In the following, a detailed description of the different embodiments of the invention is disclosed under reference to the accompanying drawings. All examples herein should be seen as part of the general description and are therefore possible to combine in any way of general terms. Individual features of the various embodiments and aspects may be combined or exchanged unless such combination or exchange is clearly contradictory to the overall function of the mobile communication device or arrangement.

Briefly described the invention relates to a mobile communication device for use in environments wherein it is beneficial for the user to avoid touch-interaction with a mobile communication device. This object is achieved through a novel solution comprising an touch-free interaction arrangement, a display adapted to be read without removing the mobile communication device from for example a pocket, and a system supporting said features. The objects are further described by the appended claims.

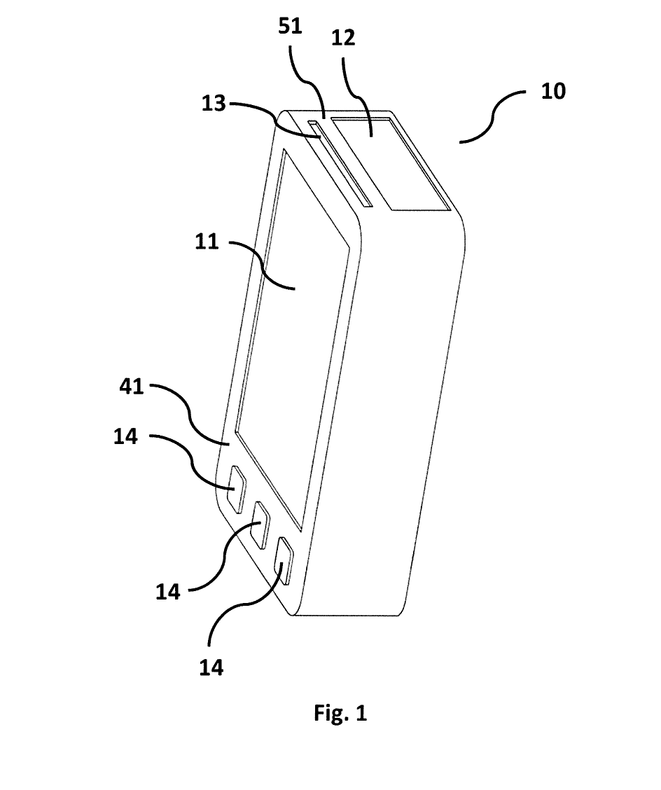

FIG. 1 illustrates a tilted isometric front/top view of a mobile communication device 10 in accordance with the present invention. The mobile communication device 10 comprises a first display 11 arranged on a front side 41, a second display 12 arranged on a top side 51, and touch-free interaction means 13 arranged on a top side 51 and adapted to allow a user to use the mobile communication device 10 without touching the device. The first 11 and second 12 displays are displays of screen types meaning that they have the ability to show different graphical information such as numbers, symbols, characters, or any other form of graphical representation.

The person skilled in the art further understands that the mobile device 10 may comprise any number and form of other interaction means such as tactile or touch buttons 14. The first 11 and second 12 displays are in one preferred embodiment of the invention touch screens. In another embodiment only the first display 11 is a touch screen. The first display 11 is in one embodiment of the invention adapted to be used for more complex interaction between the user and the device. For example, typing, reading longer paragraphs, or searching for information. The second display 12 is in a similar embodiment adapted to handle basic communication.

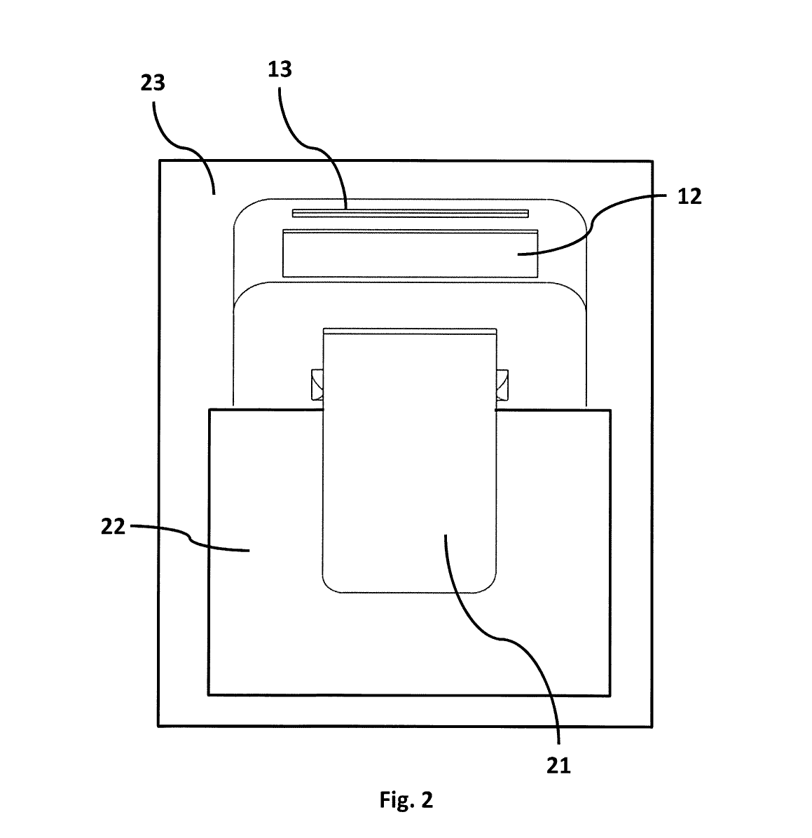

FIG. 2 shows the mobile communication device 10 placed in an operational state in a pocket 22 or case 22 of a user. The pocket 22 or case 22 might be any form of case or pocket arranged for example on a shirt 23, a jacket 23, or any other garment 23. This means that the mobile communication device 10 is placed in a way that the user still can operate some features of the mobile communication device 10 without removing it from the pocket 22 or case 22. The means 21 for holding the mobile communication device 10 in place helps securing the mobile communication device 10 to the users clothing or any other element that the mobile communication device 10 is attached to. The pocket 22 can be any form of pocket, case, belt, or other pieces of for example garment that the mobile communication device 10 can be attached to. In one preferred embodiment of the invention the mobile communication device 10 is arranged within the breast pocket 22 of a user in a way that the user with ease can look down on the second display 12 to see any messages or information.

In one embodiment the mobile communication device 10 further comprises additional means to attract the attention of the user when an event occurs, an alarm sounds, or a message is received. Such means can for example be means crating vibrations, sounds, one or more blinking LEDs, or any other form of means adopted by the person skilled in the art to attract the attention of the user.

The messages received can be any form of message including but not limited to alarms, information, requirements, calls, task assignments, and/or messages.

Solutions as presented by the prior art requires the user to in some way interact with the mobile communication device 10 physically in order to communicate. For example, a device without the second display 12 would need to be removed from the user's pocket before any visual information could be presented to the user. Device with secondary displays are normally in the prior art adapted for saving power and the arrangement of the display is not important for the function which is a significant different from the present invention. However, even if a second display where top mounted the information would still only be provided to the user. No means are by the prior art adapted for both presentation of information and for enabling the user to actively provide a response.

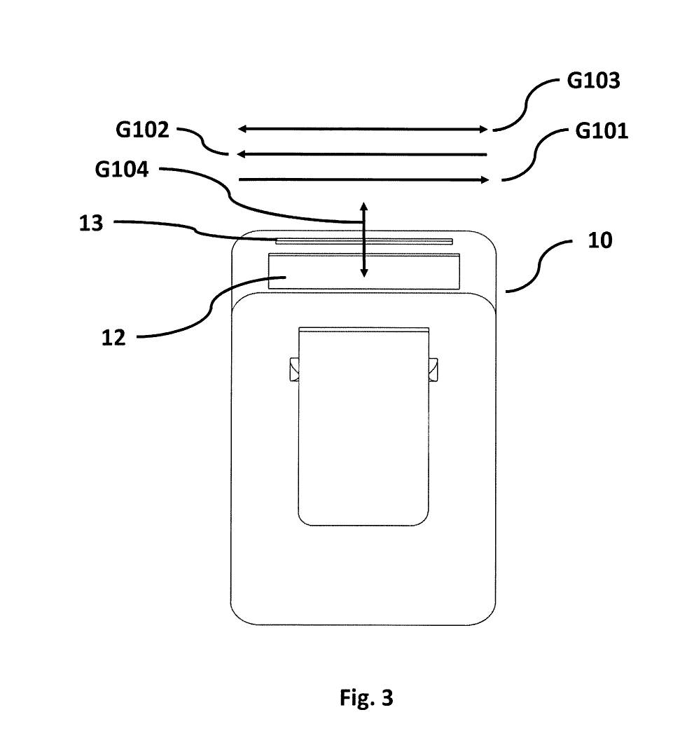

FIG. 3 illustrates one embodiment of the present invention wherein the means for touch-free interaction 13 are utilized by a user. Different gestures G101, G102, G103, G104 can be performed in the close proximity of the top surface of the mobile communication device 10 without any physical touch-interaction. The gestures may correspond to different choices, commands, or responses to a message received.

In one embodiment of the invention the user receives a message or alarm which is indicated by for example a buzz, vibration, or sound from the mobile communication device 10. The user's attention is brought to the second display 12 showing a message. In one example the user might be a doctor and the message indicates that a patient in a specific room requires assistance. The message might also for example include information about the severity and urgency of the alarm or message. By performing one of the gestures indicated in FIG. 3 the doctor might directly respond to the message, call, information, alert, assignment, or alarm. For example, a swiping movement to the left G101 might be a confirmation that the doctor will respond to the call, a swiping movement to the right G102 might indicate that the doctor will respond to the alarm later. Performing a gesture G104 in the opposite direction might be a response telling the device to forward the message, call, or alarm to the next doctor on a list of doctors close by. Other gestures such as G103 might provide additional features.

In another embodiment of the invention further means for touch-free interaction (not shown) are available. For example, in one embodiment the mobile communication device 10 comprises one or more accelerometer allowing the user to for example bump the device with his or her arm to response to an alarm or any other form of call or message. The user can interact with the mobile communication device by engaging in such a way that the accelerometer realizes the intention of the user. For example, if the user engages in a way that the accelerometer registers a sideways movement one action is performed. If the user instead engages with the mobile communication device in a way that the accelerometer registers a vertical movement another action is performed. The person skilled in the art understands that any number of movements, directions of movement, or combinations thereof can be adopted as part of the solution.

The means for touch-free interaction 13 might be any form of means for touch-free interaction such as light sensors, proximity sensors, gesture sensors, IR-sensors, or any other form of means adapted to be interacted with without physical interaction. The person skilled in the art understands that such interaction means could be used either separately or in combination with the aforementioned touch-free interaction arrangement 13.

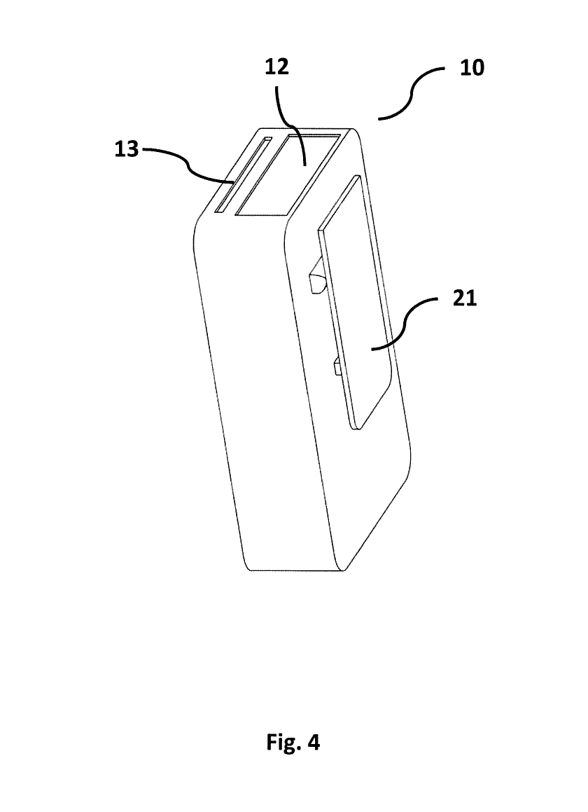

FIG. 4 illustrates an embodiment of the invention wherein the back surface of the mobile communication device 10 comprises means 21 for holding the mobile communication device in place. The means 21 for holding the mobile communication device in place is preferably a clip 21 arranged on the back surface of the mobile communication device 10. The clip 21 can be of any form or shape and could for example in one embodiment be spring loaded while in another embodiment be a fixed clip 21. The person skilled in the art understands that FIG. 4 only illustrates an exemplifying embodiment of the invention and that the mobile communication device 10, the displays 11, 12, and the clip 21 can take any form or shape that is suitable for the purpose of the invention.

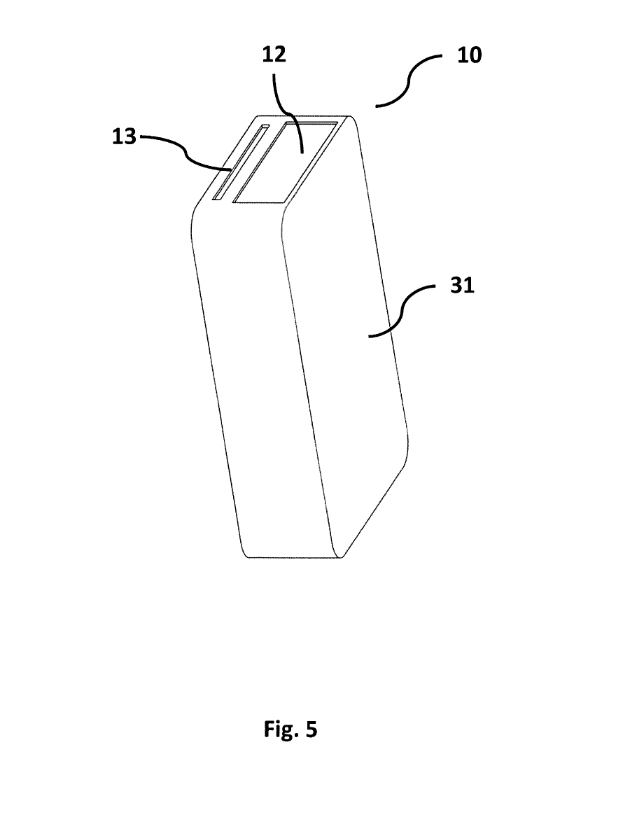

FIG. 5 illustrates another embodiment of the invention wherein the back surface 31 is a clean surface without any means for holding the mobile communication device 10 in place. In one embodiment of the invention however the back surface 31 might be of a high friction material making it serve as a means for securing the mobile communication device.

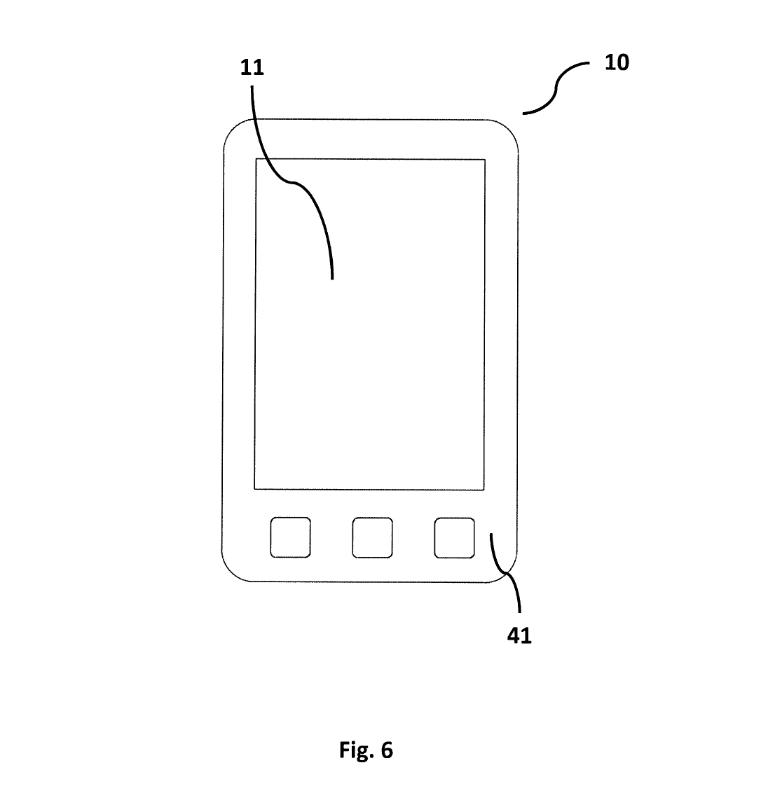

FIG. 6 illustrates a front view of the mobile communication device 10 with a front surface 41 whereon the first display 11 is arranged. The front surface 41 is substantially perpendicular to the top surface 51 whereon the second display 12 is arranged.

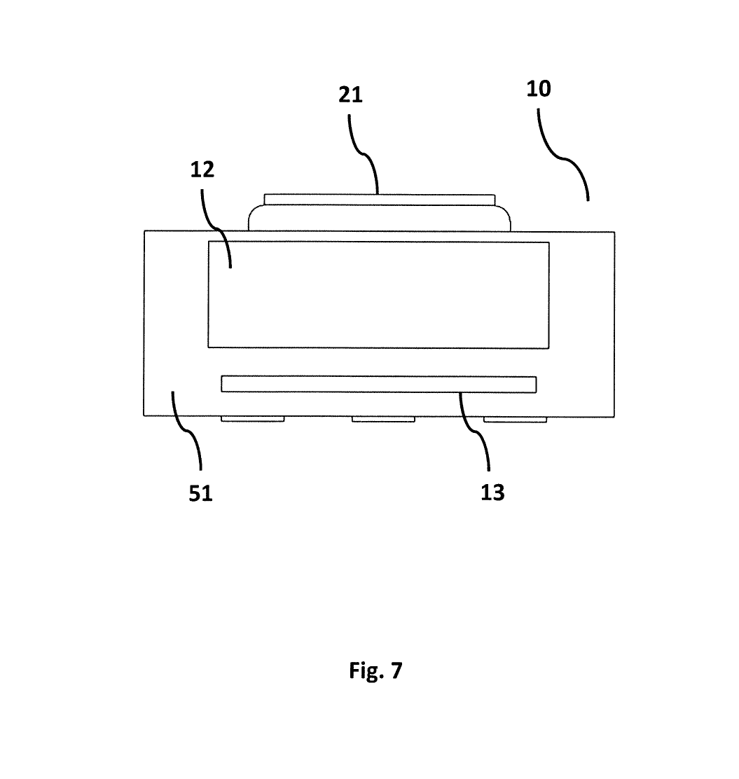

FIG. 7 illustrates a top view of the mobile communication device 10 comprising a top surface 51 substantially perpendicular to the front surface 41 whereon the first display 11 is arranged. On the top surface 51 the second display 12 and the arrangement for touch-free interaction 13 are arranged in any suitable way. The person skilled in the art understands that the top surface 51 arrangement may comprise any design or form of display and touch-free interaction arrangement 13 arranged in any suitable way.

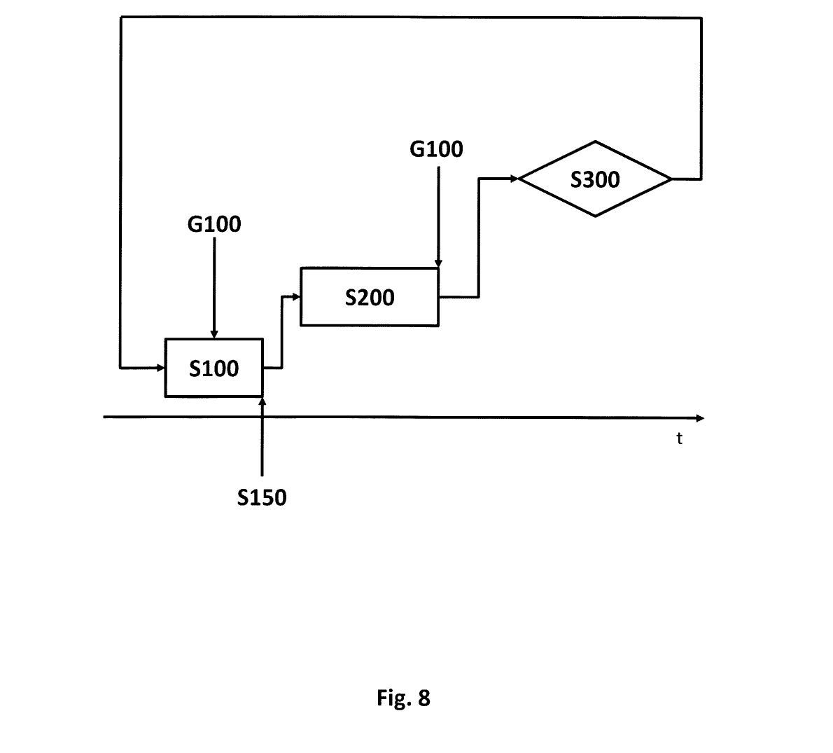

FIG. 8 illustrates a schematic view of how the mobile communication devices 10 are used in one embodiment. In the example illustrated in FIG. 8 one mobile communication device 10 is in a normal state S100. The normal state S100 means that the device may respond to user input on the first display 11 and the buttons or touch buttons 14, however the means for touch-free interaction 13 are deactivated in this state. It should be noted that in one embodiment the means for touch-free interaction might be protected from use and unlock with a certain gesture, similar to how for example a screen on a smartphone is unlocked before use.

In the normal state S100 the mobile communication device 10 is thereby not responsive to input gestures G100 from the user. However, the mobile communication device is still active and awaiting alerts, task assignments, alarms, messages, information, or calls as input S150. Upon receipt of any form of input, such as alarms, message, or calls, the mobile communication device 10 directly enters a listening state S200 wherein the mobile communication device 10 is receptive to touch-free input G100 from the user. The touch-free input G100 can for example be gestures or as previously described input from for example an accelerometer. At the same time as the mobile communication device 10 enters in to the listening state S200 the second display 12 shows the message, alarm, alert, or call intended for the user. The user can as previously described with ease read or interpret this message without moving anything else than his or her gaze direction. The user provides touch-free input G100 to the device responding on the message with for example an acceptance, denial, or forward of the message to another user. At this stage the mobile communication device generates an output S300 and returns to the normal state S100. The output S300 can for example be a response sent to one or more mobile communication devices 10a, 10b within the same or other mobile communication arrangements.

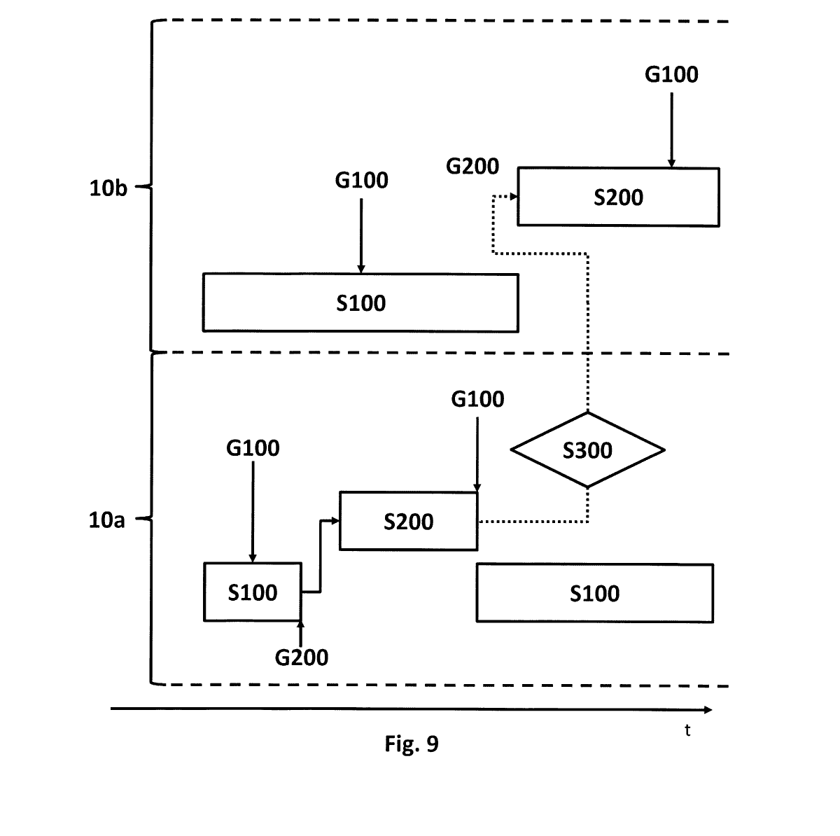

FIG. 9 illustrates a schematic view of an elaborated embodiment of FIG. 8. In this example two different mobile communication devices 10a, 10b are interacting. Both mobile communication devices 10a, 10b are in their normal state S100 where they are not receptive to the touch-free user input G100 as previously disclosed. The first mobile communication device 10a receives an input G200 with a message, alert, alarm, call, or any other similar type of information. The first mobile communication device 10a thereby enters in to the listening mode S200 enabling the possibility for input through touch-free interaction by the user. The user in this case replies with a forward input G100 creating an output S300 sending a signal to the second mobile communication device 10b. The signal between the devices is in one preferred embodiment wireless and can be sent over any suitable type of wireless protocol or network, via a base station, server or directly between the devices.

Upon receipt of the output S300, which becomes the input G200 to the second mobile communication device 10b the first mobile communication device 10a returns to its normal state S100 while the second mobile communication device 10b enters in to its listening state S200 allowing for touch-free user input G100. The user of second mobile communication device 10b thereby has the same options as the user of the first mobile communication device 10a previously had.

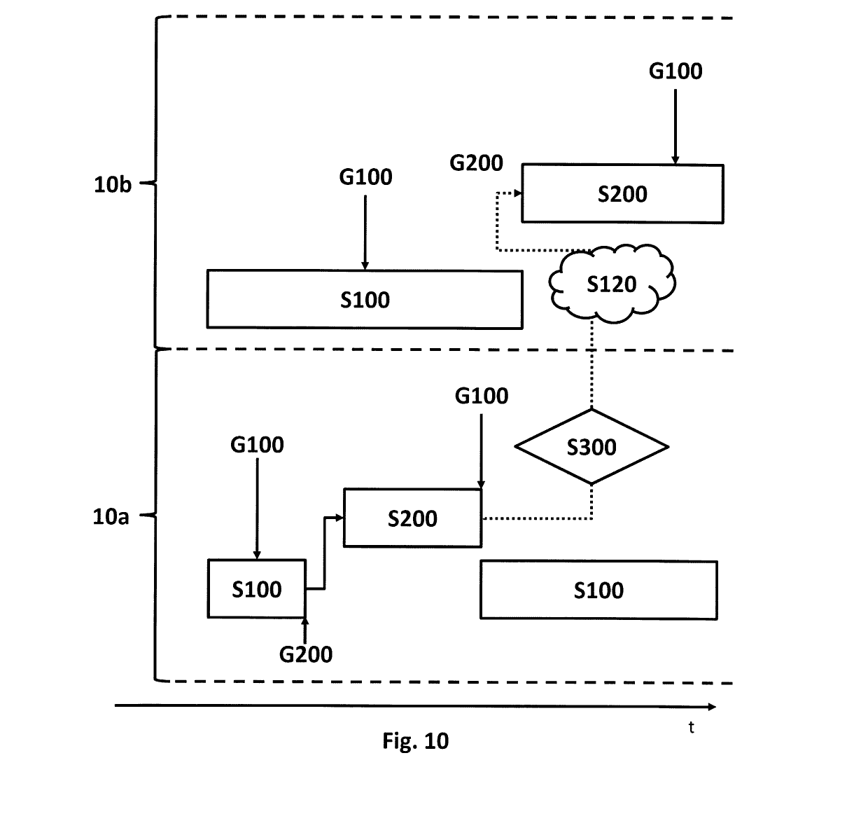

FIG. 10 illustrates an alternative embodiment of the illustration in FIG. 9 wherein the schematic view further is elaborated with a step S120 which is performed in a host 120, control station 120, node 120, or main unit 120. If a user forwards a request, or performs any other action requiring for another user to be notified, the new request is determined and generated in the host 120 through the step S120.

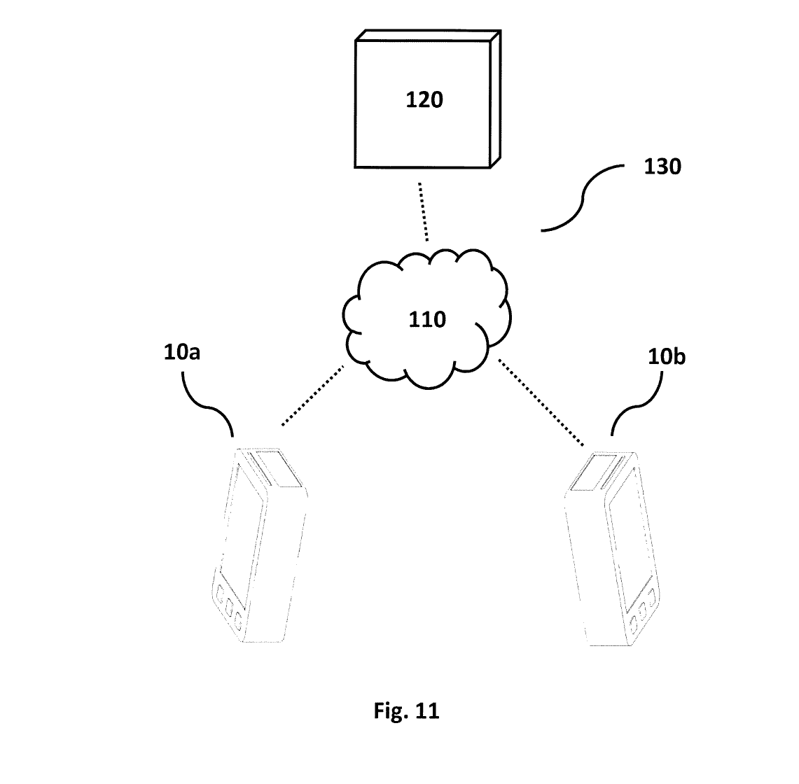

FIG. 11 shows the arrangement for mobile communication comprising multiple mobile communication device 10a, 10b, a network 110, and an optional control station 120, node 120, or main unit 120, that might serve as a main unit for the mobile communication arrangement 130. However, the person skilled in the art understands that the main unit 120 in one embodiment of the invention is optional and can be eliminated in favor of a node to node communication system between the mobile communication devices 10a, 10b.

The arrangement for mobile communication further in one preferred embodiment comprises means to determine the location of each device. Such determination can for example be an absolute position or a distance to a target. The location information is used to prioritize which user to send a specific message to. For example, in the embodiment wherein the user is a doctor operating in a hospital, alarms are sent out to doctors regarding patients or staff that needs assistance. The mobile communication arrangement 130 can with the aid of the locations of each device determine which doctor that is the closest to the room where assistance is required and thereby provide the message to that doctor. However, if said doctor carrying for example the mobile communication device 10a is busy he or she might forward the alarm to the next doctor, for example carrying the mobile communication device 10b.

In addition to the aforementioned location information each user can also have an associated title or area of expertise that in one embodiment provides additional information to the mobile communication arrangement 130 regarding which device to send an alarm, a message, or a call to. For example, if a specific medical doctor is more suitable than another to response to a certain type of alarm the mobile communication arrangement will chose that doctor even in situations where he or she might be in a room that is located further away from the alarm or message. This is in one embodiment part of the information priority system. The person skilled in the art understands that any such determination may be adopted for each situation and algorithms may be developed for specific purposes. Thresholds can further be adjusted in order to determine when the suitability of a certain doctor no longer is of relevance due to the distance, or in some cases even send multiple alarm signals to both a specialist in the field and a user close by in order to cover both for a quick response and providing a specialist to the right room.

In one embodiment of the invention the location information and priority arrangement might be located in the mobile communication arrangement.

In one embodiment of the invention the means to determine the location of a mobile communication device is used by the information priority system as the only or one out of many parameters deciding which user to send information to. Information as used in the application above and below can be any form of information such as a phone call, message, alert, alarm, assignment of task, data, or any other form of information to be sent to a mobile communication device. For example, if a certain event happens that requires the attention of a medical doctor with specialist knowledge within a specific field. The information priority system might utilize both a list of which users that fulfils that requirements as well as the information from the location determination in order to send the information to the most suited user.

The information might be either divided by area of expertise or prioritized based on other parameters. For example, in one embodiment of the invention the information priority system utilizes different parameters to decide whom to send information to. The first parameter might be a list of currently active users determining which users that currently are on duty. The next parameter might be users that are qualified to respond to the specific information that is about to be sent. Additionally, other parameters such as the location of the user, if the person is currently busy, or any other parameters might be taken into consideration by the information priority system.

The person skilled in the art understands that all information might be either true/false or in the form of a prioritized list. For example, person A is more qualified than person B but person B is closer to the location where the assistance is required. In such a case the information priority system might perform a valuation of different parameters deciding to notify either one of person A or person B, or both depending on the situation. In some situations notifying only person B would be sufficient but in another notifying both would create both a quick response and in a longer time frame also alerting the most suited person.

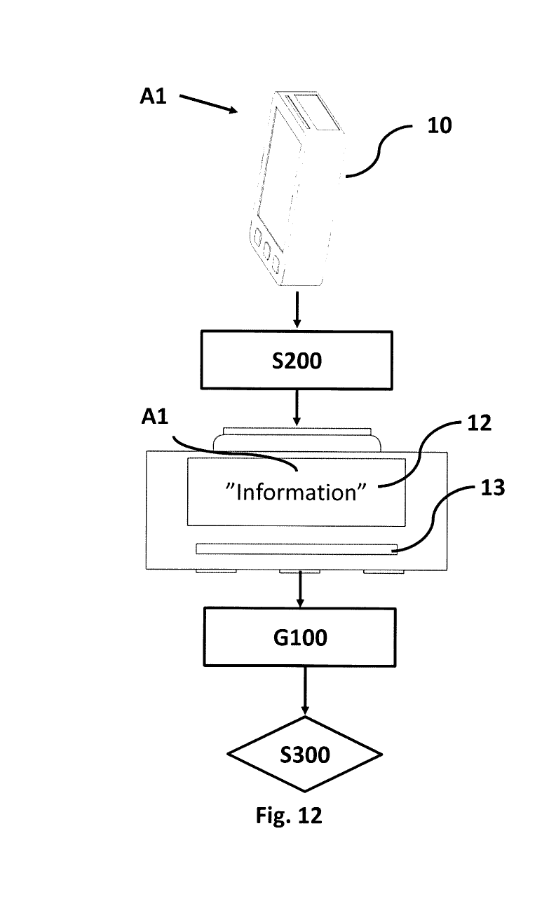

FIG. 12 illustrates a schematic view of steps performed when information A1 is received to a mobile communication device 10. In one embodiment of the invention information A1 is sent to the mobile communication device 10. The information A1 can be any form of information such as a message, an alert, a task assignment, or an alarm. Upon receipt of the information A1 the touch-free interaction arrangement 13 is activated through the entering of the listening mode S200. Previously, or substantially at the same time, the user is made aware of that information A1 has been received through for example vibrations, sounds, blinking lights, or any other forms of means to alert the user that the information has been received at the mobile communication device 10. The information A1 is shown on the second display 12 and the touch-free interaction arrangement 13 is active for receipt of user input G100. When the user performs for example a gesture G101, G102, G103, G0104 it is interpreted as an input G100 and the mobile communication device generates output S300 based on the user input G100.

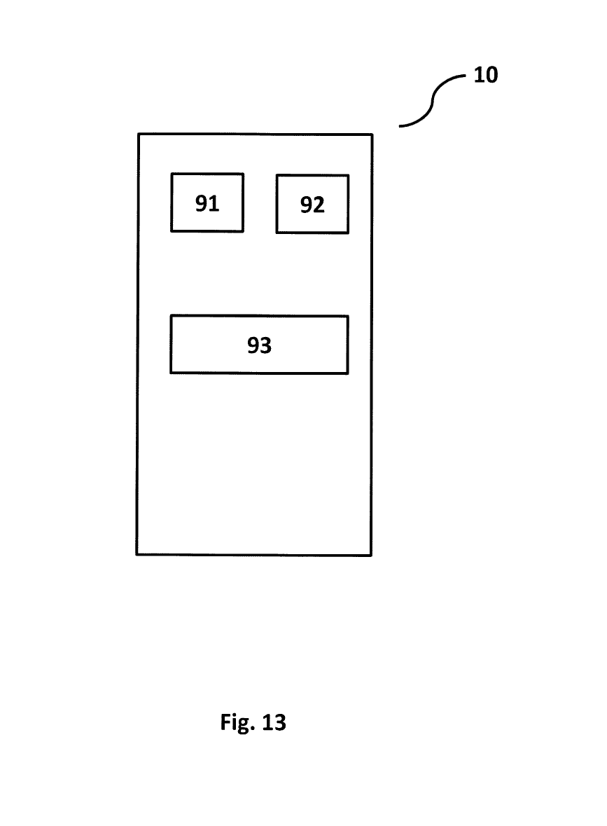

FIG. 13 illustrates a chart of some critical components 91, 92, 93 of the mobile communication device 10. The mobile communication device comprises a memory 91, a processor 92, and a communication arrangement 93, such as a communication chip 93 for communication over for example WiFi, 3G, LTE, Bluetooth, or GSM.

The person skilled in the art understands that the invention and the features that characterize the invention as described in the appended claims are useful in other areas than clinical environments as well. For example, working forces with the opposite relation where the user has dirty hands can have equal benefits from a solution in accordance with the present invention. Such users might for example be vehicle mechanics, construction workers, and road workers.

It should be noted that in the detailed description above any embodiment or feature of an embodiment are only examples and could be combined in any way if such combination is not clearly contradictory.

1. A mobile communication device comprising a first and second display adapted to present information to a user, wherein said first display is arranged on a front side of said mobile communication device, and said second display is arranged, substantially perpendicular to said front side, on a top side of said mobile communication device, wherein said mobile communication device further comprises a touch-free interaction arrangement arranged on the top side of said mobile communication device and said touch-free interaction arrangement solely can be used when said second display is in an active mode.

2. The mobile communication device according to claim 1, wherein said touch-free interaction arrangement comprises a movement sensor, preferably an accelerometer, a gyro, or a level.

3. The mobile communication device according to claim 1, wherein said touch-free interaction arrangement is adapted to receive user input and determine differences between gestures performed in close vicinity of said touch-free interaction arrangement.

4. The mobile communication device according to claim 1, wherein said mobile communication device further is adapted to be arranged to communicate with a mobile communication arrangement, wherein said mobile communication arrangement comprises an information priority system, preferably in a host.

5. The mobile communication device according to claim 1, further comprising means for mechanically securing said mobile communication device to a surrounding physical arrangement, such as a breast pocket of a user.

6. The mobile communication device according to claim 5, wherein said means for securing said mobile communication device is a clip adapted to secure said mobile communication device to enable a clear view of said second display for said user.

7. The mobile communication device according to claim 1, wherein said mobile communication device further comprises means to enable determination of the location of said mobile communication device.

8. The mobile communication device according to claim 1, wherein said mobile communication device comprises a single button located on the front side below said first display, a proximity sensor arranged above said first display, and volume buttons on one of the sides perpendicular to both said front side and said top side, wherein the touch-free interaction arrangement and the second display are arranged under a collective housing on said top surface.

9. The mobile communication device according to claim 4, wherein the mobile communication device is adapted to receive prioritized information from the priority system based on at least one parameter chosen from user qualifications, user position, user work load, and if the user is on duty or not.

10. A method in a mobile communication device comprising a first and second display adapted to present information to a user, said first display arranged on a front side of said mobile communication device, and said second display arranged, substantially perpendicular to said front side, on a top side of said mobile communication device, wherein said mobile communication device further comprising a touch-free interaction arrangement arranged on the top side of said mobile communication device for enabling touch-free interaction, the method comprising the steps:
receiving a message to said mobile communication device,
presenting said message on the second display so that a user can interpret the information without touching or moving said mobile communication device,
enabling said touch-free interaction arrangement in response to receiving the message,
receiving input from a user through said enabled touch-free interaction arrangement, and
generating an output based on said input.

11. A computer program comprising computer readable code means, which when run in a mobile communication device according to claim 1 causes the mobile communication device to perform the steps:
waiting for incoming digital input in a normal state,
receiving digital input,
upon receipt of said digital input enter a listening state and start listening for user input,
upon receipt of said user input produce an output, and
returning to said normal state.

12. The computer program according to claim 11 wherein said user input are gestures performed in the close vicinity of said touch-free interaction arrangement.
